(19) United States
(12) Patent Application Publication
(10) Pub. No.: US 2010/0281205 A1
(43) Pub. Date: Nov. 4, 2010

(54) Micro Control Module For Universal Connection And Universal Connection Method Thereof

(75) Inventors: CHAO-MING SUNG, Taipei (TW); Jiao-Saie Young, Taipei (TW); Ming-Huang Tseng, Taipei (TW)

Correspondence Address: Juan Carlos A. Marquez;c/o Stites & Harbison PLLC, 1199 North Fairfax Street, Suite 900, Alexandria, VA, 22314-1437, US

(73) Assignee: CeraMicro Technology Corporation, Taipei (TW)

(21) Appl. No.: 12/630,877

(22) Filed: Dec. 4, 2009

Related U.S. Application Data
(60) Provisional application No. 61/174,021, filed on Apr. 30, 2009.

(51) Int. Cl. G06F 12/02

(52) U.S. Cl. 711/103; 711/E12.008

(57) ABSTRACT

A micro control module for universal connection and a universal connection method thereof are provided. The micro control module includes a supporting interface module, a micro control unit, and a memory unit. The micro control unit is configured to read interface-setting data saved in the supporting interface module and save the interface-setting data into the memory unit. When a wireless transmission module is electrically connected to the micro control module, the micro control unit generates an identification result, selects the appropriate interface-setting data from the memory unit, and reads the corresponding initialization data from the supporting interface module, so as to initialize the wireless transmission module.

### BACKGROUND OF THE INVENTION

1. Technical Field

The present invention relates to a micro control module for universal connection and a universal connection method thereof. More particularly, the present invention relates to a micro control module for universal connection and a universal connection method thereof that are applicable to micro control modules.

2. Description of Related Art

A micro control unit (MCU) is the product of integrating a computer system into a single chip. MCUs not only effectively downsize electronic products but can also be designed for specific applications. Therefore, MCUs have a very wide range of applications that include medical electronics, industrial control, automobile electronics, consumer electronics, and so forth.

In the consumer electronics industry, for example, where competition is intense, a strong market share depends largely on the ability to shorten the time to market (TTM), cut costs effectively, and provide more functions. In view of this, MCU manufacturers have endeavored to enhance the performance of MCUs. While it is generally desired that MCUs are capable of operating in a low-power mode, withstanding high-voltage actuation, and providing ease of use, a major research and development direction for MCU manufacturers nowadays is to equip MCUs with communication functions.

Presently, communication techniques can generally be categorized as wire-based or wireless, and are implemented via Ethernet, Universal Serial Bus (USB), Local Interconnect Network (LIN), Controller Area Network (CAN), Zigbee, and so on. An MCU is endowed with communication capabilities by integration with a communication module. However, MCUs from different manufacturers have different connection interfaces and internal functions.

Therefore, for a communication module to be integrated with an MCU, the communication module must be customized according to the connection interfaces of the MCU, which nevertheless results in high costs and low yield. In addition, the various internal functions of MCUs from different manufacturers tend to prolong the integration testing process and lead to an undesirably extended time to market (TTM).

### BRIEF SUMMARY OF THE INVENTION

It is an objective of the present invention to provide a micro control module for universal connection and a universal connection method thereof, wherein a plurality of interface-setting data entries are saved in the micro control module to facilitate the reading of the interface-setting data that correspond to different interfaces. Thus, the micro control module is enabled to connect with wireless transmission modules having different interfaces.

It is another objective of the present invention to provide a micro control module for universal connection and a universal connection method thereof, wherein the micro control module is capable of universal connection with different wireless transmission modules. Hence, when the micro control module is applied to an external MCU, wireless transmission modules to be connected with the external MCU need not be customized according to the external MCU. As a result, the time and costs required for developing the external MCU can be reduced.

To achieve the above and other objectives, the present invention provides a micro control module for universal connection, wherein the micro control module includes a supporting interface module, an MCU, and a memory unit. The supporting interface module saves a plurality of interface-setting data entries and a plurality of initialization data entries that correspond to the interface-setting data. The MCU is electrically connected to the supporting interface module and configured for reading the interface-setting data. The memory unit is electrically connected to the MCU. The MCU saves the interface-setting data into the memory unit, selects the appropriate interface-setting data from the memory unit according to an identification result, and reads the initialization data that correspond to the selected interface-setting data, so as to initialize a wireless transmission module accordingly.

To achieve the above and other objectives, the present invention also provides a universal connection method for connecting with wireless transmission modules, wherein the universal connection method is applicable to a micro control module for universal connection, and the micro control module includes a supporting interface module, an MCU, and a memory unit. The universal connection method includes the steps of: initializing an external MCU; reading from the supporting interface module, wherein the supporting interface module saves a plurality of interface-setting data entries and a plurality of initialization data entries that correspond to the interface-setting data, and wherein the MCU reads from the supporting interface module and saves the interface-setting data into the memory unit; selecting particular interface-setting data, wherein the MCU selects the appropriate interface-setting data from the memory unit according to an identification result; selecting particular initialization data, wherein the MCU selects from the supporting interface module the initialization data that correspond to the selected interface-setting data; and initializing a wireless transmission module, wherein the MCU initializes the wireless transmission module according to the selected initialization data.

Implementation of the present invention at least involves the following inventive steps:

1. With the plurality of interface-setting data entries being saved in advance, the micro control module can select the appropriate interface-setting data according to the type or model of the wireless transmission module. Thus, the micro control module is capable of universal connection with wireless transmission modules having different interfaces.

2. Since the micro control module is capable of universal connection with wireless transmission modules having different interfaces, the micro control module can be applied to an external MCU so as to accelerate the development of the external MCU and reduce related costs.

### BRIEF DESCRIPTION OF THE SEVERAL VIEWS OF THE DRAWINGS

A detailed description of further features and advantages of the present invention is given below so that a person skilled in the art can understand and implement the technical contents of the present invention and readily comprehend the objectives and advantages thereof by reviewing the teachings disclosed herein and the appended claims in conjunction with the accompanying drawings, in which:

FIG. 1 is a block diagram of a micro control module for universal connection according to an embodiment of the present invention;

FIG. 2 is a flowchart of a universal connection method for connecting with wireless transmission modules according to another embodiment of the present invention; and

FIG. 3 is a flowchart for selecting particular interface-setting data according to the present invention.

### DETAILED DESCRIPTION OF THE INVENTION

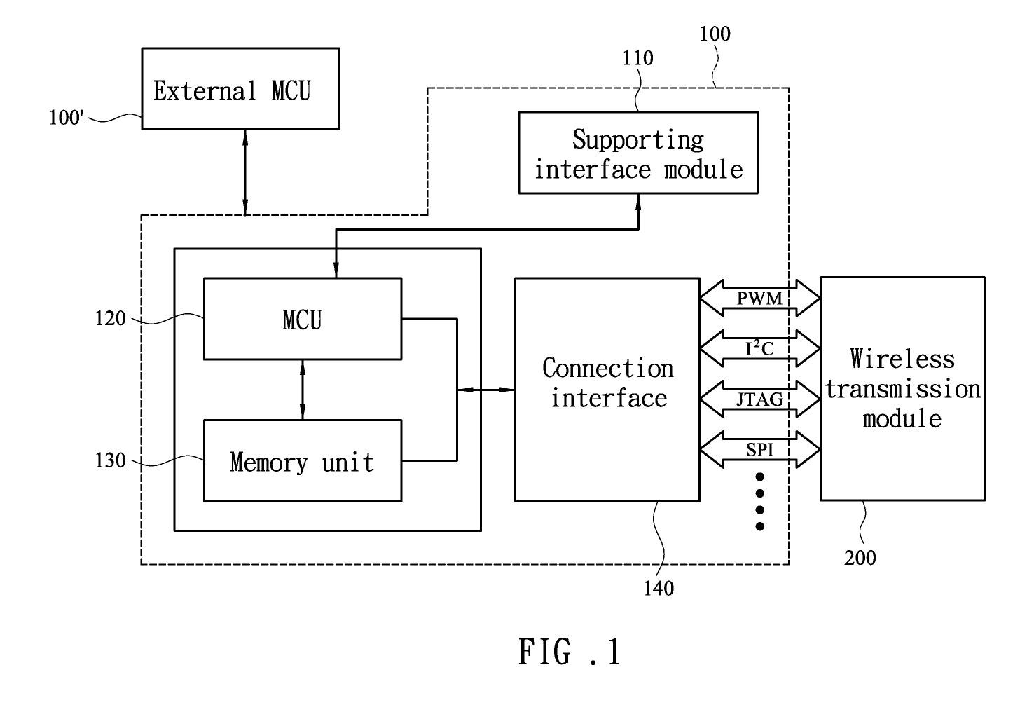

Referring to FIG. 1, a micro control module 100 for universal connection according to an embodiment of the present invention includes a supporting interface module 110, a micro control unit (MCU) 120, and a memory unit 130.

The supporting interface module 110 is an electrically erasable programmable read-only memory (EEPROM) or a flash memory. The supporting interface module 110 saves a plurality of interface-setting data entries and a plurality of initialization data entries, wherein each interface-setting data entry corresponds to a specific initialization data entry. Furthermore, each interface-setting data entry and the corresponding initialization data entry are the data required for setting a wireless transmission module 200 of a different model. In other words, the supporting interface module 110 saves the interface-setting data and initialization data of wireless transmission modules 200 of different models.

As shown in FIG. 1, the MCU 120 is electrically connected to the supporting interface module 110. The MCU 120 is configured for reading the interface-setting data from the supporting interface module 110.

The memory unit 130 is electrically connected to the MCU 120. The memory unit 130 is a random access memory (RAM). The MCU 120 saves the interface-setting data read from the supporting interface module 110 into the memory unit 130.

When the micro control module 100 is electrically connected to a wireless transmission module 200, the MCU 120 transmits a first testing message to the wireless transmission module 200 and receives a second testing message in response therefrom. The MCU 120 compares the first and second testing messages and generates an identification result. The comparison process is explained in detail below.

Based on the identification result, the MCU 120 selects the appropriate interface-setting data from the memory unit 130. Then, the MCU 120 reads from the supporting interface module 110 the initialization data that correspond to the selected interface-setting data, so as to initialize the wireless transmission module 200 accordingly.

In addition, the MCU 120 is configured to perform bit reorganization on packets transmitted by the wireless transmission module 200, wherein bit reorganization refers to, for example, bit slicing, change of data length, re-combination, encoding, and decoding. The wireless transmission module 200 is ZigBee-based or Bluetooth-based. Moreover, the micro control module 100 and the wireless transmission module 200 are independent chips that are connected together or packaged as a system-on-ship.

With reference to FIG. 1, the micro control module 100 further includes a plurality of connection interfaces 140, such as a Joint Test Action Group (JTAG) interface, an Inter-Integrated Circuit (I²C) interface, a Pulse-Width Modulation (PWM) interface, a General Purpose Input/Output (GPIO) interface, or a Serial Peripheral Interface (SPI).

Each connection interface 140 is electrically connected to the MCU 120 and the memory unit 130. Therefore, the micro control module 100 for universal connection can select the connection interface 140 matching the type of the wireless transmission module 200 and thus connect with wireless transmission modules 200 of various types.

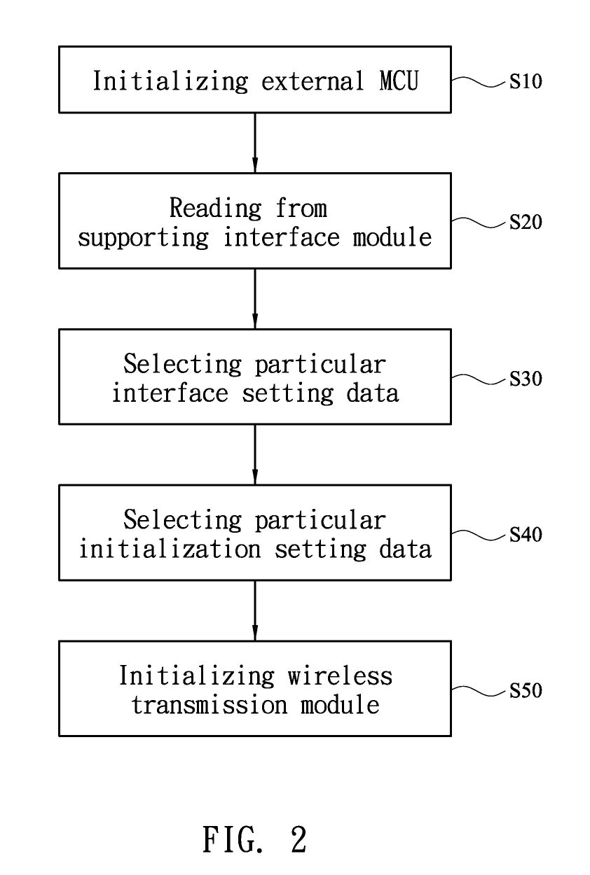

Referring to FIG. 2, according to another embodiment of the present invention, a universal connection method for connecting with wireless transmission modules 200 is applicable to the foregoing micro control module 100 for universal connection and includes the steps of: initializing an external MCU (S10); reading from the supporting interface module (S20); selecting particular interface-setting data (S30); selecting particular initialization data (S40); and initializing a wireless transmission module (S50).

The step of initializing an external MCU (S10) is described as follows. When electrically connected to an external MCU 100′, the micro control module 100 for universal connection initializes the external MCU 100′ by initializing a control register, a clock, a memory, and a serial interface of the external MCU 100′.

Since the external MCU 100′ can be an MCU of any model available on the market, it is feasible to save the initialization settings of MCUs of various brands and various models beforehand into the memory unit 130 of the micro control module 100. For example, the 78F0502 MCU 100′ of NEC is provided with a 1 KB RAM, a 24 KB flash memory, a 20 MHz clock, and so on. Thus, when the micro control module 100 is electrically connected to the external MCU 100′, the micro control module 100 can automatically find the matching initialization settings and initialize the external MCU 100′ accordingly.

The step of reading from the supporting interface module (S20) is carried out in the following manner. After initializing the external MCU 100′, the micro control module 100 reads from the supporting interface module 110, which saves a plurality of interface-setting data entries and a plurality of initialization data entries. The MCU 120 reads the interface-setting data and saves the interface-setting data into the memory unit 130 of the micro control module 100 (as shown in FIG. 1).

The supporting interface module 110 is an EEPROM or a flash memory while the memory unit 130 is a RAM.

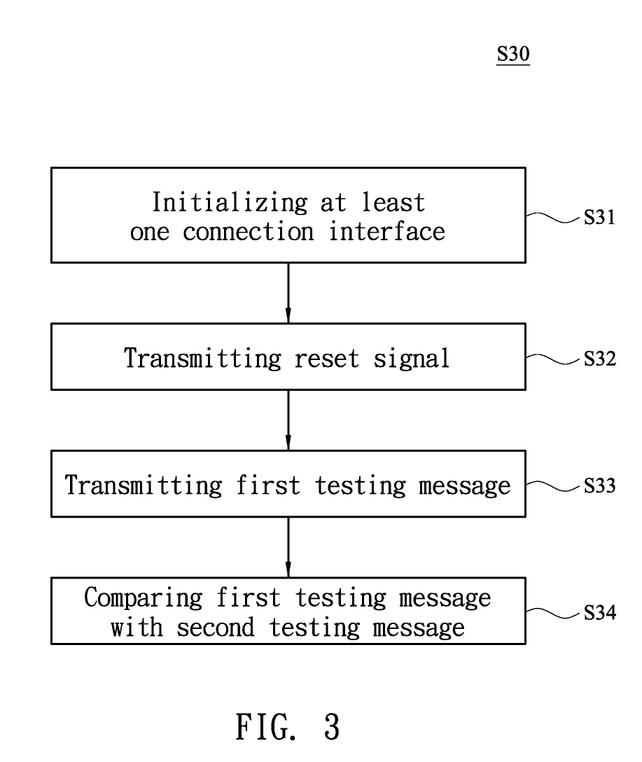

At the step of selecting particular interface-setting data (S30), the MCU 120 selects particular interface-setting data according to an identification result. Referring to FIG. 3, the step of selecting particular interface-setting data (S30) includes: initializing at least one connection interface (S31), transmitting a reset signal (S32), transmitting a first testing message (S33), and comparing the first testing message with a second testing message (S34).

As shown in FIG. 1 and FIG. 3, immediately after the micro control module 100 is electrically connected to an external wireless transmission module 200, the micro control module 100 having the plurality of connection interfaces 140 is ignorant of which connection interface 140 is suitable for the wireless transmission module 200. To identify the suitable connection interface 140, it is necessary for the micro control module 100 to initialize at least one of the connection interfaces 140 so that the initialized connection interface 140 transmits a reset signal to the wireless transmission module 200.

After the reset signal is transmitted, the MCU 120 of the micro control module 100 transmits a first testing message to a buffer unit of the wireless transmission module 200. When the buffer unit receives the first testing message, the wireless transmission module 200 replies a second testing message to the MCU 120. The buffer unit of the wireless transmission module 200 can be a first-in first-out (FIFO) unit.

The MCU 120 compares the first testing message and the second testing message, determines if the two testing messages are identical, and generates the identification result accordingly. If the first testing message is identical to the second testing message, it is determined that this specific connection interface 140 is suitable for the wireless transmission module 200; otherwise, this connection interface 140 is not suitable.

Upon determining that the first testing message and the second testing message are not the same, the MCU 120 selects another connection interface 140 and transmits the first testing message to the wireless transmission module 200 again. Thus, after repeated comparisons, the connection interface 140 suitable for the wireless transmission module 200 is identified.

Referring back to FIG. 2, at the step of selecting particular initialization data (S40), the MCU 120 having selected the appropriate interface-setting data selects from the supporting interface module 110 the initialization data that correspond to the selected interface-setting data.

At the step of initializing a wireless transmission module (S50), the MCU 120, which has selected the appropriate initialization data, initializes the wireless transmission module 200 connected through the correct connection interface 140, according to the selected initialization data.

When an external MCU 100′ of an arbitrary model is electrically connected to the micro control module 100 for universal connection, a connection between the external MCU 100′ and the wireless transmission module 200 can be established through the micro control module 100, thereby rapidly expanding the function of the external MCU 100′. Furthermore, as the micro control module 100 is capable of changing the configuration of packets transmitted by the wireless transmission module 200, the configurations of packets transmitted by different external MCUs 100′ can be unified. Thus, signal communication between two external MCUs 100′ can be achieved through wireless transmission, thereby reducing the time and costs for developing the external MCUs 100′.

The foregoing embodiments are illustrative of the characteristics of the present invention so as to enable a person skilled in the art to gain insight into the contents disclosed herein and implement the present invention accordingly. The embodiments, however, are not intended to restrict the scope of the present invention. Hence, all equivalent modifications and variations which do not depart from the spirit and principle of the present invention should fall within the scope of the appended claims.

What is claimed is:

1. A micro control module for universal connection, comprising:
a supporting interface module saving a plurality of interface-setting data entries and a plurality of initialization data entries corresponding to the interface-setting data;
a micro control unit (MCU) electrically connected to the supporting interface module and configured for reading the interface-setting data; and
a memory unit electrically connected to the micro control unit, wherein the micro control unit saves the interface-setting data into the memory unit, selects particular said interface-setting data from the memory unit according to an identification result, and reads particular said initialization data that correspond to the selected interface-setting data, so as to initialize a wireless transmission module accordingly.

2. The micro control module of claim 1, wherein the supporting interface module is an electrically erasable programmable read-only memory (EEPROM).

3. The micro control module of claim 1, wherein the supporting interface module is a flash memory.

4. The micro control module of claim 1, wherein the memory unit is a random access memory (RAM).

5. The micro control module of claim 1, wherein the micro control unit transmits a first testing message to the wireless transmission module, receives a second testing message replied from the wireless transmission module, and compares the first testing message and the second testing message, so as to generate the identification result.

6. The micro control module of claim 1, further comprising a plurality of connection interfaces electrically connected to the micro control unit and the memory unit.

7. The micro control module of claim 6, wherein each said connection interface is a Joint Test Action Group (JTAG) interface, an Inter-Integrated Circuit (I²C) interface, a Pulse-Width Modulation (PWM) interface, a General Purpose Input/Output (GPIO) interface, or a Serial Peripheral Interface (SPI).

8. A universal connection method for connecting with wireless transmission modules, wherein the universal connection method is applicable to a micro control unit for universal connection, and the micro control module comprises a supporting interface module, a memory unit, and a micro control unit (MCU), the universal connection method comprising steps of:
initializing an external micro control unit;
reading from the supporting interface module, wherein the supporting interface module saves a plurality of interface-setting data entries and a plurality of initialization data entries corresponding to the interface-setting data, and wherein the micron control unit reads from the supporting interface module and saves the interface-setting data into the memory unit;
selecting particular said interface-setting data, wherein the micro control unit selects particular said interface-setting data from the memory unit according to an identification result;
selecting particular said initialization data, wherein the micro control unit selects from the supporting interface module particular said initialization data that correspond to the selected interface-setting data; and
initializing a said wireless transmission module, wherein the micro control unit initializes the wireless transmission module according to the selected initialization data.

9. The universal connection method of claim 8, wherein the supporting interface module is an electrically erasable programmable read-only memory (EEPROM).

10. The universal connection method of claim 8, wherein the supporting interface module is a flash memory.

11. The universal connection method of claim 8, wherein the memory unit is a random access memory (RAM).

12. The universal connection method of claim 8, wherein the step of initializing the external micro control unit comprises initializing a control register, a clock, a memory, and a serial interface of the external micro control unit.

13. The universal connection method of claim 8, wherein the step of selecting particular said interface-setting data comprises:
initializing at least one connection interface;
transmitting a reset signal to the wireless transmission module, by the initialized connection interface;
transmitting a first testing message to a buffer unit of the wireless transmission module, by the micro control unit, so that the buffer unit replies a second testing message to the micro control unit; and
comparing the first testing message and the second testing message so as to generate the identification result.

14. The universal connection method of claim 13, wherein the buffer unit is a first-in first-out (FIFO) unit.
